(19) United States
(12) Patent Application Publication
(10) Pub. No.: US 2015/0221938 A1
(43) Pub. Date: Aug. 6, 2015

(54) NONAQUEOUS ELECTROLYTE SECONDARY BATTERY

(71) Applicant: SANYO Electric Co., Ltd., Daito-shi, Osaka (JP)

(72) Inventors: Takashi Yamamoto, Hyogo (JP); Masanori Sugimori, Hyogo (JP); Manabu Takijiri, Osaka (JP); Junichi Sugaya, Osaka (JP); Masanobu Takeuchi, Hyogo (JP); Katsunori Yanagida, Hyogo (JP); Takeshi Ogasawara, Hyogo (JP)

(73) Assignee: SANYO ELECTRIC CO., LTD., Daito-shi, Osaka (JP)

(21) Appl. No.: 14/423,975

(22) PCT Filed: Sep. 5, 2013
(86) PCT No.: PCT/JP2013/005254

§ 371 Date: Feb. 25, 2015

(30) Foreign Application Priority Data
Sep. 28, 2012 (JP) 2012-217926
Mar. 29, 2013 (JP) 2013-073419

(51) Int. Cl. H01M 4/36; H01M 10/0568; H01M 4/525; H01M 4/485; H01M 4/505

(52) U.S. Cl. CPC H01M 4/366; H01M 4/485; H01M 4/505; H01M 4/525; H01M 10/0568; H01M 10/052

(57) ABSTRACT

In a nonaqueous electrolyte secondary battery including a positive electrode containing a positive electrode active material, a negative electrode, and a nonaqueous electrolyte, the positive electrode active material contains a lithium transition metal oxide having a surface to which a rare earth compound is adhered, and the nonaqueous electrolyte contains a lithium salt in which an oxalate complex functions as an anion.

### TECHNICAL FIELD

The present invention relates to a nonaqueous electrolyte secondary battery.

### BACKGROUND ART

Since having a high energy density and a high capacity, a nonaqueous electrolyte secondary battery has been widely used as a drive electric source of a mobile information terminal, such as a mobile phone or a notebook personal computer. In recent years, higher attention has also been paid to the nonaqueous electrolyte secondary battery as a power electric source of an electric tool or an electric car. The power electric source has been required to increase a capacity so as to be usable for a long period of time and improve large current discharge cycle characteristics in which a large current is discharged repeatedly in a relatively short period of time.

Since a positive electrode active material contains a transition metal having a catalytic function, for example, a decomposition reaction of an electrolyte solution occurs, and as a result, a problem in that a coating film inhibiting large current discharge is formed on the surface of the positive electrode active material may arise. For example, Patent Literature 1 has proposed that by the use of a positive electrode active material containing lanthanum atoms at the surface thereof, a decomposition reaction with an electrolyte solution is suppressed.

Patent Literature 2 has proposed that an electrolyte solution is configured to contain at least lithium bis(oxalato)borate (LiBOB) at a concentration of 0.2 mole/liter together with LiPF₆ to form a good passive coating film on a negative electrode active material, and cycle characteristics and low-temperature discharge performance after cycles are improved.

### CITATION LIST

### Patent Literature

PTL 1: Japanese Published Unexamined Patent Application No. 2008-226495

PTL 2: Japanese Published Unexamined Patent Application No. 2008-159588

### SUMMARY OF INVENTION

### Technical Problem

However, according to the techniques disclosed in the above Patent Literatures 1 and 2, the large current discharge performance cannot be sufficiently improved.

An object of one embodiment of the present invention is to provide a nonaqueous electrolyte secondary battery which is able to improve the large current discharge performance.

### Solution to Problem

According to one embodiment of the present invention, in a nonaqueous electrolyte secondary battery including a positive electrode containing a positive electrode active material, a negative electrode, and a nonaqueous electrolyte, the positive electrode active material contains a lithium transition metal oxide having a surface to which a rare earth compound is adhered, and the nonaqueous electrolyte contains a lithium salt in which an oxalate complex functions as an anion.

### Advantageous Effects of Invention

According to one embodiment of the present invention, the large current discharge performance can be improved.

### BRIEF DESCRIPTION OF DRAWINGS

FIG. 1 is a schematic cross-sectional view showing a cylindrical nonaqueous electrolyte secondary battery according to one embodiment of the present invention.

FIG. 2 is a schematic cross-sectional view showing a three-electrode type test battery according to one embodiment of the present invention.

### DESCRIPTION OF EMBODIMENTS

According to one embodiment of the present invention, a positive electrode active material contains a lithium transition metal oxide having a surface to which a rare earth compound is adhered, and a nonaqueous electrolyte contains a lithium salt in which an oxalate complex functions as an anion. It is believed that since the rare earth compound adhered to the surface of the lithium transition metal oxide is allowed to react during charge, with the lithium salt in which an oxalate complex functions as an anion in the nonaqueous electrolyte, a good coating film having lithium ion conductivity is formed on the surface of the lithium transition metal oxide. Hence, a decrease in reaction rate of insertion and desorption of lithium ions can be suppressed, and the characteristics during large current discharge can be dramatically improved. Accordingly, one embodiment of the present invention is significantly effective, for example, in tool application in which discharge at a large current of 5 It or 10 It is required. In addition, one embodiment of the present invention also has an effect similar to that described above when a current of 2 It or more is discharged. Although the above good coating film is mainly formed during a first charge in many cases, it is believed that the coating film may also be formed during a second charge or a charge performed thereafter.

As described above, the lithium salt (in order to discriminate this salt from a lithium salt functioning as a solute which will be described later, the lithium salt is called “lithium salt functioning as an additive” in some cases) in which an oxalate complex functions as an anion according to one embodiment of the present invention is allowed to react during charge, with the rare earth compound on the surface of the lithium transition metal oxide to form a good coating film.

The above lithium salt functioning as an additive may be a lithium salt in which an oxalate complex (C₂O₄²⁻ is coordinated to a central atom) functions as an anion, and for example, a salt represented by Li[M(C₂O₄)ₓR_{y}] (in the formula, M represents an element selected from transition metals and elements of Groups XIII, XIV, and XV of the periodic table, R represents a group selected from halogen, an alkyl group, and a halogenated alkyl group, x represents a positive integer, and y represents 0 or a positive integer) may be used. In this case, M in the above formula preferably represents boron or phosphorus. In particular, besides LiBOB(Li[B(C₂O₄)₂]), for example, Li[B(C₂O₄)F₂], Li[P(C₂O₄) F₄], and Li[P(C₂O₄)₂F₂] may also be mentioned. However, in consideration of cycle characteristics at an ordinary temperature or a high temperature, LiBOB is most preferable.

The content of the lithium salt functioning as an additive per one liter of the nonaqueous electrolyte is preferably 0.005 to 0.5 moles and more preferably 0.01 to 0.2 moles.

When the amount of the lithium salt functioning as an additive is excessively small, a reaction with the rare earth compound may not be sufficiently carried out, and as a result, it may be difficult to sufficiently form a good coating film in some cases. On the other hand, when the amount of the lithium salt functioning as an additive is excessively large, since the thickness of the coating film is increased, a lithium insertion/desorption reaction is inhibited, and as a result, the large current discharge cycle characteristics may be degraded in some cases.

The above rare earth compound is preferably a rare earth hydroxide, a rare earth oxyhydroxide, or a rare earth oxide and particularly preferably a rare earth hydroxide or a rare earth oxyhydroxide. The reason for this is that by the use of those compounds, the above functional effect can be further enhanced. In addition, in the rare earth compound, a rare earth carbonate compound, a rare earth phosphoric acid compound, and the like may also be partially contained besides the compounds mentioned above.

As the rare earth element contained in the above rare earth compound, scandium, yttrium, lanthanum, cerium, praseodymium, neodymium, samarium, europium, gadolinium, terbium, dysprosium, holmium, erbium, thulium, ytterbium, and ruthenium may be mentioned. Among those mentioned above, neodymium, samarium, and erbium are preferable. The reason for this is that since a neodymium compound, a samarium compound, and an erbium compound each have a smaller average particle diameter than that of each of the other rare earth compounds, those compounds are each likely to be uniformly precipitated on the surface of the positive electrode active material.

As particular examples of the above rare earth compounds, for example, neodymium hydroxide, neodymium oxyhydroxide, samarium hydroxide, samarium oxyhydroxide, erbium hydroxide, and erbium oxyhydroxide may be mentioned. In addition, as the rare earth compound, when lanthanum hydroxide or lanthanum oxyhydroxide is used, since lanthanum is inexpensive, the manufacturing cost of a positive electrode can be reduced.

The average particle diameter of the above rare earth compound is preferably 1 to 100 nm and more preferably 10 to 50 nm. When the average particle diameter of the rare earth compound is more than 100 nm, since the particle diameter of the rare earth compound is excessively large as compared to that of the lithium transition metal oxide, the surface of the lithium transition metal oxide is not densely covered with the rare earth compound. As a result, since the area at which the lithium transition metal oxide particle is directly brought into contact with the nonaqueous electrolyte and/or reduced decomposition products thereof is increased, oxidation decomposition of the nonaqueous electrolyte and/or the reduced decomposition products thereof is enhanced, and as a result, charge/discharge characteristics may be degraded in some cases.

On the other hand, when the average particle diameter of the rare earth compound is less than 1 nm, since the particle surface of the lithium transition metal oxide is excessively densely covered with the rare earth compound, occlusion and release performance of lithium ions on the particle surface of the lithium transition metal oxide is degraded, and as a result, the charge/discharge characteristics may be degraded in some cases.

As a method to adhere the above rare earth compound to the surface of the lithium transition metal oxide, a method may be mentioned in which after an aqueous solution in which a rare earth element salt (such as an erbium salt) is dissolved is mixed with a solution in which the lithium transition metal oxide is dispersed so that the rare earth element salt is adhered to the surface of the lithium transition metal oxide, a heat treatment is performed.

As the heat treatment temperature, a temperature of 120° C. to 700° C. is preferable, and a temperature of 250° C. to 500° C. is more preferable. When the temperature is less than 120° C., since moisture adsorbed on the active material cannot be sufficiently removed, moisture may be adversely mixed into a battery in some cases. On the other hand, when the temperature is more than 700° C., since the rare earth compound adhered to the surface is diffused inside and is difficult to stay on the surface of the active material, the effect becomes difficult to obtain. In particular, when the temperature is set to 250° C. to 500° C., moisture can be removed, and furthermore, the state in which the rare earth compound is selectively adhered to the surface can be formed. When the temperature is more than 500° C., the rare earth compound on the surface is partially diffused inside, and the effect may be degraded in some cases.

In addition, as another method, a method may be mentioned in which after an aqueous solution in which a rare earth element salt (such as an erbium salt) is dissolved is sprayed while the lithium transition metal oxide is being mixed, drying and heat treatment are sequentially performed in this order. The heat treatment temperature is similar to that of the heat treatment in the case of the above method in which the aqueous solution is mixed.

Furthermore, as still another method, a method may also be mentioned in which the lithium transition metal oxide and the rare earth compound are mixed together by using a mixing machine so as to mechanically adhere the rare earth compound to the surface of the lithium transition metal oxide, and after the adhesion, a heat treatment similar to that described above is performed.

Among those methods described above, the first described method and the spray method are preferable, and in particular, the first described method is preferable. That is, a method in which an aqueous solution in which the rare earth salt, such as an erbium salt, is dissolved is mixed with a solution in which the lithium transition metal oxide is dispersed is preferably used. The reason for this is that by the method described above, the rare earth compound can be more uniformly dispersed and adhered to the surface of the lithium transition metal oxide. In this method, the pH of the solution in which the lithium transition metal oxide is dispersed is preferably set constant, and in particular, in order that particles having a size of 1 to 100 nm are uniformly dispersed and precipitated on the surface of the lithium transition metal oxide, the pH is preferably controlled to be 6 to 10. When the pH is less than 6, the transition metal of the lithium transition metal oxide may be adversely precipitated in some cases. In contrast, when the pH is more than 10, the rare earth compound may be segregated in some cases.

The rate of the rare earth element to the total molar amount of the transition metal of the lithium transition metal oxide is preferably 0.003 to 0.25 percent by mole. When the rate is less than 0.003 percent by mole, the effect to adhere the rare earth compound may not be sufficiently obtained, and on the other hand, when the rate is more than 0.25 percent by mole, since the lithium ion conductivity at the particle surface of the lithium transition metal oxide is decreased, the large current discharge cycle characteristics may be degraded in some cases.

The above lithium transition metal oxide preferably has a layered structure and is preferably represented by the general formula of LiMeO₂ (where Me represents at least one type selected from the group consisting of Ni, Co, and Mn).

However, the type of lithium transition metal oxide is not limited to that described above, and for example, a compound formed of a lithium transition metal oxide having an olivine structure represented by the general formula of LiMePO₄ (Me represents at least one type selected from the group consisting of Fe, Ni, Co, and Mn) or a compound formed of a lithium transition metal oxide having a spinel structure represented by the general formula of LiMe₂O₄ (Me represents at least one type selected from the group consisting of Fe, Ni, Co, and Mn) may also be used. In addition, the lithium transition metal oxide may further contain at least one type selected from the group consisting of magnesium, aluminum, titanium, chromium, vanadium, iron, copper, zinc, niobium, molybdenum, zirconium, tin, tungsten, sodium, and potassium, and among those mentioned above, aluminum is preferably contained. As particular examples of lithium transition metal oxides which are preferably used, for example, LiCoO₂, LiNiO₂, LiNi_{1/3}Co_{1/3}Mn_{1/3}O₂, LiFePO₄, LiMn₂O₄, and LiNi_{0.8}Co_{0.15}Al_{0.05}O₂ may be mentioned. In addition, a lithium cobaltate, a lithium nickel cobalt manganate, and a lithium nickel cobalt aluminate may be more preferably mentioned, and a lithium nickel cobalt manganate and a lithium nickel cobalt aluminate may be particularly preferably mentioned.

In this case, as the lithium transition metal oxide, when a lithium cobaltate, a lithium nickel cobalt manganate, or a lithium nickel cobalt aluminate is used, the large current discharge characteristics are significantly improved. The reason for this is believed that a coating film formed on the surface of the lithium cobaltate, the lithium nickel cobalt manganate, or the lithium nickel cobalt aluminate has specifically excellent lithium ion conductivity.

As the above lithium nickel cobalt manganate, the range of the general formula of LiₐNiₓCo_{y}Mn_{z}O₂ (0.95<a<1.20, 0.30≦x≦0.80, 0.10≦y≦0.40, and 0.10≦z≦0.50) is preferably satisfied, and furthermore, the range of the general formula of LiₐNiₓCo_{y}Mn_{z}O₂ (0.95<a<1.20, 0.30≦x≦0.60, 0.20≦y≦0.40, and 0.20≦z≦0.40) is preferably satisfied. In particular, the range of the general formula of LiₐNiₓCo_{y}Mn_{z}O₂ (0.95<a<1.20, 0.35≦x≦0.55, 0.20≦y≦0.35, and 0.25≦z≦0.30) is more preferable.

When the value of a is 0.95 or less, since the stability of the crystalline structure is decreased, the capacity retention and the large current discharge characteristics during cycles become insufficient. In contrast, the reason is that when the value of a is 1.20 or more, the amount of gas generation is increased.

When the value of x is less than 0.30, and/or the value of y is more than 0.40, the charge/discharge capacity is gradually decreased. In contrast, when the value of x is more than 0.80 and/or the value of y is less than 0.10, since the lithium diffusion rate in the active material is gradually decreased, and the rate-determining step of the reaction is shifted from the surface of the active material to the inside thereof, a sufficient effect may not be obtained.

In addition, when the value of z is less than 0.10, replacement in element arrangement between some nickel atoms and lithium in the crystalline structure is liable to occur, and as a result, degradation in large current discharge characteristics occurs. When the value of z is more than 0.50, the structure becomes unstable, and a lithium nickel cobalt manganate is difficult to stably obtain during active material synthesis.

As the lithium nickel cobalt aluminate, the range of the general formula of LiₐNiₓCo_{y}Al_{z}O₂ (0.95<a<1.20, 0.50≦x≦0.99, 0.01≦y≦0.50, and 0.01≦z≦0.10) is preferably satisfied, and furthermore, the range of the general formula of LiₐNiₓCo_{y}Al_{z}O₂ (0.95<a<1.20, 0.70≦x≦0.95, 0.05≦y≦0.30, and 0.01≦z≦0.10) is more preferably satisfied.

When the value of a is 0.95 or less, since the stability of the crystalline structure is decreased, the capacity retention and the large current discharge characteristics during cycles become insufficient. In contrast, the reason is that when the value of a is 1.20 or more, the amount of gas generation is increased.

When the value of x is less than 0.50, and/or the value of y is more than 0.50, the charge/discharge capacity is gradually decreased. In contrast, when the value of z is more than 0.10, since the lithium diffusion rate in the active material is decreased, and the rate-determining step of the reaction is shifted from the surface of the active material to the inside thereof, a sufficient effect may not be obtained.

In addition, when the value of x is more than 0.99, the value of z is less than 0.01, and/or the value of y is less than 0.01, the structure stability is decreased.

A solvent of the nonaqueous electrolyte is not particularly limited, and solvents which have been used in the past for nonaqueous electrolyte secondary batteries may be used. For example, there may be used a cyclic carbonate, such as ethylene carbonate, propylene carbonate, butylene carbonate, or vinylene carbonate; a chain carbonate, such as dimethyl carbonate, ethyl methyl carbonate, or diethyl carbonate; a compound including an ester, such as methyl acetate, ethyl acetate, propyl acetate, methyl propionate, ethyl propionate, or γ-butyrolactone; a compound including a sulfone group such as propane sultone; a compound including an ether, such as 1,2-dimethoxyethane, 1,2-diethoxyethane, tetrahydrofuran, 1,2-dioxane, 1,4-dioxane, or 2-methyltetrahydrofuran; a compound including a nitrile, such as butyronitrile, valeronitrile, n-heptane nitrile, succinonitrile, glutaric nitrile, adiponitrile, pimelonitrile, 1,2,3-propanetricarbonitrile, or 1,3,5-pentanetricarbonitrile; and a compound containing an amide, such as dimethylformamide. In particular, a solvent in which at least one H of each of the compounds is substituted by F may also be preferably used. In addition, those compounds mentioned above may be used alone, or at least two thereof may be used in combination, and in particular, a solvent in which a cyclic carbonate and a chain carbonate are mixed in combination and a solvent in which a small amount of a compound including a nitrile and/or a compound including an ether is further mixed with the solvent described above in combination are preferable.

In addition, as the nonaqueous solvent of the nonaqueous electrolyte, an ionic liquid may also be used, and in this case, cationic species and anionic species are not particularly limited; however, in view of low viscosity, electrochemical stability, and hydrophobicity, in particular, pyridium cations, imidazolium cations, or quaternary ammonium cations, which function as cations, and fluorine-containing imide-based anions functioning as anions are preferably used in combination.

Furthermore, as a solute used in the above nonaqueous electrolyte, a lithium salt in which an oxalate complex functions as an anion and a known lithium salt which has been generally used in a nonaqueous electrolyte secondary battery may be used by mixing. In addition, as the lithium salt described above, a lithium salt containing at least one type selected from P, B, F, O, S, N, and Cl may be used, and in particular, a lithium salt, such as LiPF₆, LiBF₄, LiCF₃SO₃, LiN(FSO₂)₂, LiN(CF₃SO₂)₂, LiN(C₂F₅SO₂)₂, LiN(CF₃SO₂)(C₄F₉SO₂), LiC(C₂F₅SO₂)₃, LiAsF₆, or LiClO₄, and a mixture thereof may be used. In particular, in order to improve highly efficient charge/discharge characteristics and durability of the nonaqueous electrolyte secondary battery, LiPF₆ is preferably used.

Incidentally, besides the case in which the above solute is used alone, at least two types thereof may be used by mixing. In addition, although the concentration of the solute is not particularly limited, a concentration of 0.8 to 1.7 moles per one liter of the nonaqueous electrolyte is preferable. In addition, for application in which discharge at a large current is required, the concentration of the solute is preferably set to 1.0 to 1.6 moles per one liter of an electrolyte solution.

As a negative electrode active material, a material is not particularly limited as long as being able to reversibly occlude and release lithium, and for example, a carbon material, a metal or an alloy material, each of which forms an alloy with lithium, and a metal oxide may be used. In addition, in view of material cost, a carbon material is preferably used for the negative electrode active material, and for example, natural graphite, artificial graphite, mesophase pitch-based carbon fibers (MCF), mesocarbon micro beads (MCMB), cokes, and hard carbon may be used. In particular, in order to improve highly efficient charge/discharge characteristics, as the negative electrode active material, a carbon material formed by covering a graphite material with low-crystalline carbon is preferably used.

As a separator, any separators which have been used in the past may be used. In particular, besides a separator formed of a polyethylene, a separator formed of a polyethylene provided with a polyethylene layer on the surface thereof and a separator formed by applying an aramid-based resin or the like on the surface of a separator formed of a polyethylene may be used.

At the interface between the positive electrode and the separator or at the interface between the negative electrode and the separator, a layer containing an inorganic filler which has been used in the past may be formed. As the filler, an oxide or a phosphate compound using at least one selected from titanium, aluminum, silicon, magnesium, and the like, which have been used in the past, may be used, or the compound described above may also be used after the surface thereof is treated with a hydroxide or the like. In addition, for the formation of the above filler layer, a formation method in which a filler-containing slurry is directly applied to the positive electrode, the negative electrode, or the separator, or a method in which a sheet formed from the filler is adhered to the positive electrode, the negative electrode, or the separator may be used.

### EXAMPLES

Hereinafter, although one embodiment of the present invention will be described in more detail with reference to concrete examples, the present invention is not limited at all to the following examples and may be appropriately changed and modified without departing from the scope of the present invention.

### First Example

### Example

### Synthesis of Positive Electrode Active Material

First, 1,000 g (10.34 mol) of particles of a lithium nickel cobalt manganate represented by LiNi_{0.55}Co_{0.20}Mn_{0.25}O₂ was charged to 3 liters of purified water and was then stirred. Next, a solution in which 4.58 g (10.33 mmol) of erbium nitrate pentahydrate was dissolved was added to the mixture described above. In this case, an aqueous sodium hydroxide solution at a concentration of 10 percent by mass was appropriately added so as to control the pH of the solution containing the lithium nickel cobalt manganate to be 9. Subsequently, after suction filtration and washing with water were sequentially performed, a heat treatment was performed in an air atmosphere at 400° C. for 5 hours, so that a lithium nickel cobalt manganate having a surface to which erbium oxyhydroxide was uniformly adhered was obtained. In addition, the adhesion amount of the erbium oxyhydroxide based on the erbium element was 0.1 percent by mole with respect to the total moles of the transition metals of the above lithium nickel cobalt manganese.

[Formation of Positive Electrode]

With 94 parts by mass of the positive electrode active material, 4 parts by mass of carbon black functioning as a carbon conductive agent and 2 parts by mass of a poly(vinylidene fluoride) functioning as a binder were mixed, and furthermore, an appropriate amount of NMP (N-methyl-2-pyrolidone) was added to the above mixture, so that a positive electrode slurry was prepared. Next, the positive electrode slurry was applied to two surfaces of a positive electrode collector formed of aluminum and was then dried. Finally, after rolling was performed using rollers, a predetermined electrode size was obtained by cutting, and a positive electrode lead was further fitted thereto, so that a positive electrode was formed.

[Formation of Negative Electrode]

Next, 97.5 parts by mass of artificial graphite functioning as a negative electrode active material, 1 part by mass of a carboxymethyl cellulose functioning as a thickener, and 1.5 parts by mass of a styrene-butadiene rubber functioning as a binder were mixed together, and an appropriate amount of purified water was added thereto, so that a negative electrode slurry was prepared. Next, this negative electrode slurry was applied to two surface of a negative electrode collector formed of copper foil and was then dried. Finally, after rolling was performed using rollers, a predetermined electrode size was obtained by cutting, and a negative electrode lead was further fitted thereto, so that a negative electrode was formed.

[Preparation of Nonaqueous Electrolyte Solution]

In a mixed solvent in which EC (ethylene carbonate), EMC (ethyl methyl carbonate), DMC (dimethyl carbonate), PC (propylene carbonate), and FEC (fluoroethylene carbonate) were mixed together at a volume ratio of 10:10:65:5:10, LiPF₆ functioning as a solute and lithium bis(oxalato)borate were dissolved to have a concentration of 1.5 mole/liter and a concentration of 0.01 mole/liter, respectively, so that a nonaqueous electrolyte solution was prepared.

[Formation of Battery]

The positive electrode and the negative electrode were disposed to face each other with at least one separator formed of a polyethylene-made fine porous film provided therebetween and were then wound around a winding core to forma spiral shape. Next, after the winding core was removed to form an electrode body having a spiral shape, this electrode body was inserted in a metal-made outer package can, and the above nonaqueous electrolyte solution was then charged therein. Subsequently, the outer package can was further sealed, so that a 18650-type nonaqueous electrolyte secondary battery (capacity: 2.1 Ah) having a battery size with a diameter of 18 mm and a height of 65 mm was formed. Hereinafter, the battery formed as described above was called a battery A.

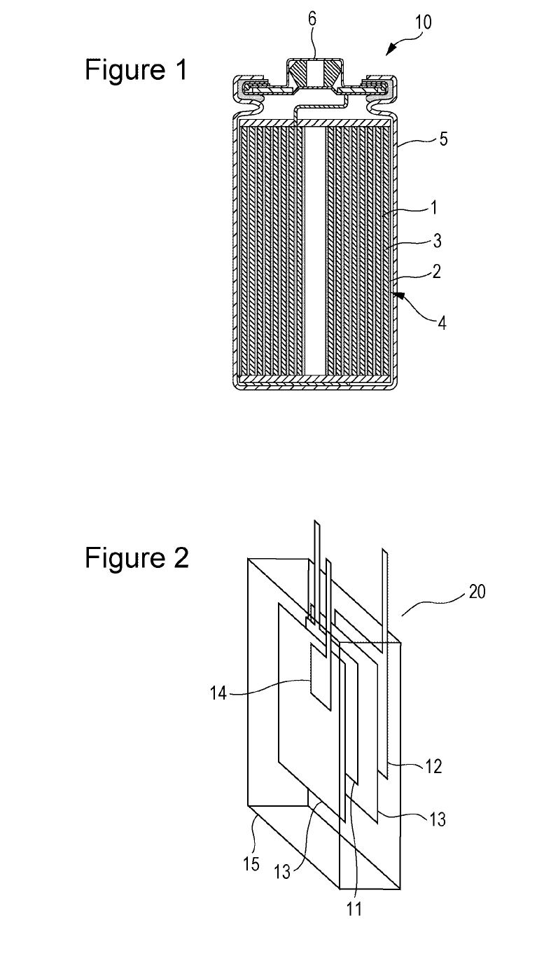

FIG. 1 is a schematic cross-sectional view showing the nonaqueous electrolyte secondary battery formed as described above. As shown in FIG. 1, an electrode body 4 formed of a positive electrode 1, a negative electrode 2, and a separator 3 was inserted in a negative electrode can 5. A sealing body 6 also functioning as a positive electrode terminal was arranged at an upper side of the negative electrode can 5 and was then fixed by caulking thereof, so that a nonaqueous electrolyte secondary battery 10 was formed.

### Comparative Example 1

Except that no erbium oxyhydroxide was adhered to the surface of the lithium nickel cobalt manganate, and no lithium bis(oxalato)borate was added to the electrolyte solution, a battery was formed in a manner similar to that of the above example. Hereinafter, the battery thus formed was called a battery Z1.

### Comparative Example 2

Except that no lithium bis(oxalato)borate was added to the electrolyte solution, a battery was formed in a manner similar to that of the above example. Hereinafter, the battery thus formed was called a battery Z2.

### Comparative Example 3

Except that no erbium oxyhydroxide was adhered to the surface of the lithium nickel cobalt manganate, a battery was formed in a manner similar to that of the above example. Hereinafter, the battery thus formed was called a battery Z3.

<Evaluation of Low Temperature Discharge Performance>

The low temperature discharge performance of each of the above batteries A and Z1 to Z3 was evaluated under the following conditions.

Charge/Discharge Conditions

Under a temperature condition at 25° C., constant current charge was performed at a charge current of 1 It (2.1 A) until the battery voltage reached 4.35 V, and furthermore, constant voltage charge was performed at a constant battery voltage of 4.35 V until the current reached 0.02 It (0.042 A). Subsequently, the battery was then moved to a place in an environment at a temperature of −20° C., and under the conditions in which constant current discharge was performed at a discharge current of 9.52 It (20 A), a battery voltage measured 0.1 seconds after the start of the discharge was obtained. The results are shown in Table 1.

TABLE 1

| | Presence of | | Voltage Measured |
|---|---|---|---|
| | Adhesion | Presence | 0.1 Seconds after |
| Bat- | of Erbium | of | Discharge at 20 A |
| tery | Oxyhydroxide | LiBOB | and at −20° C. (V) |
| A | Yes | Yes | 2.463 |
| Z1 | No | No | 2.398 |
| Z2 | Yes | No | 2.402 |
| Z3 | No | Yes | 2.371 |

As shown in Table 1, in the battery A according to the present invention, compared to the batteries Z1 to Z3 of the comparative examples, the decrease in voltage measured 0.1 seconds after the start of large current discharge at a low temperature is suppressed. Hence, it is found that the large current discharge performance in a low temperature environment is excellent. The reason for this is believed that in the battery A, a good coating film having excellent lithium ion conductivity is formed on the surface of the lithium transition metal oxide. Although the reaction mechanism thereof has not been clearly understood yet, the following mechanism may be considered. In consideration of the electronegativity of rare earth elements, since being next to an alkaline earth element in terms of positive degree, a rare earth element is an element having excellent reactivity among transition metal elements. Hence, a rare earth element has a high electron-withdrawing property. On the other hand, an oxalate complex has a high electron-releasing property. Accordingly, it is believed that when charge is performed, since the rare earth element and the oxalate complex are selectively bonded to each other, the coating film is formed on the positive electrode active material. Since this oxalate complex bonded to the rare earth element is likely to be coordinated with lithium ions in the nonaqueous electrolyte, it is believed that the coating film formed by the oxalate complex and the rare earth compound adhered to the lithium transition metal oxide is excellent in lithium ion conductivity.

In the battery A of the present invention, although LiBOB is used as the lithium salt in which an oxalate complex functions as an anion, by the reasons described above, the lithium salt is not limited to LiBOB, and in the case in which a lithium salt in which another oxalate complex functions as an anion is used, it is believed that an effect similar to that described above may also be obtained.

### Second Example

### Example 1

Except that a nonaqueous electrolyte solution was prepared in such a way that lithium bis(oxalato)borate was dissolved in the electrolyte solution to have a concentration of 0.03 mole/liter, a battery was formed in a manner similar to that of the example of the first example. Hereinafter, the battery thus formed was called a battery B1.

### Example 2

Except that a nonaqueous electrolyte solution was prepared in such a way that lithium bis(oxalato)borate was dissolved in the electrolyte solution to have a concentration of 0.06 mole/liter, a battery was formed in a manner similar to that of the example of the first example. Hereinafter, the battery thus formed was called a battery B2.

### Example 3

Except that a nonaqueous electrolyte solution was prepared in such a way that lithium bis(oxalato)borate was dissolved in the electrolyte solution to have a concentration of 0.1 mole/liter, a battery was formed in a manner similar to that of the example of the first example. Hereinafter, the battery thus formed was called a battery B3.

### Example 4

Except that a nonaqueous electrolyte solution was prepared in such a way that lithium bis(oxalato)borate was dissolved in the electrolyte solution to have a concentration of 0.2 mole/liter, a battery was formed in a manner similar to that of the example of the first example. Hereinafter, the battery thus formed was called a battery B4.

<Evaluation of Low Temperature Discharge Performance>

The low temperature discharge performance of each of the above batteries B1 to B4 was evaluated under conditions similar to those of the first example, and a battery voltage measured 0.1 seconds after the start of discharge was obtained. The results are shown in Table 2.

TABLE 2

| | Presence of | | Voltage Measured |
|---|---|---|---|
| | Adhesion | Presence | 0.1 Seconds after |
| Bat- | of Erbium | of LiBOB | Discharge at 20 A |
| tery | Oxyhydroxide | (Concentration) | and at −20° C. (V) |
| A | Yes | Yes | 2.463 |
| | | (0.01 mole/liter) | |
| B1 | Yes | Yes | 2.452 |
| | | (0.03 mole/liter) | |
| B2 | Yes | Yes | 2.428 |
| | | (0.06 mole/liter) | |
| B3 | Yes | Yes | 2.435 |
| | | (0.1 mole/liter) | |
| B4 | Yes | Yes | 2.415 |
| | | (0.2 mole/liter) | |
| Z2 | Yes | No | 2.402 |

As shown in Table 2, in the batteries A and B1 to B4 according to the present invention, it is found that compared to the battery Z2 of the comparative example, the decrease in voltage measured 0.1 seconds after the start of large current discharge at a low temperature is suppressed, and the large discharge current performance in a low temperature environment is excellent. Hence, it is found that when the rate of LiBOB per one liter of the nonaqueous electrolyte is 0.01 to 0.2 moles, the above good coating film (coating film formed by the rare earth compound adhered to the lithium transition metal oxide and the oxalate complex) excellent in lithium ion conductivity is reliably formed on the surface of the lithium transition metal oxide.

### Third Example

### Example 1

### Synthesis of Positive Electrode Active Material

Except that a lithium nickel cobalt manganate represented by LiNi_{0.35}Co_{0.35}Mn_{0.30}O₂ was used instead of using the lithium nickel cobalt manganate represented by LiNi_{0.55}Co_{0.20}Mn_{0.25}O₂, a positive electrode active material was synthesized in a manner similar to that of the example of the first example, and a lithium nickel cobalt manganate having a surface to which erbium oxyhydroxide was uniformly adhered was obtained. In addition, the adhesion amount of the erbium oxyhydroxide based on the erbium element was 0.1 percent by mole with respect to the total moles of the transition metals of the above lithium nickel cobalt manganese.

[Formation of Positive Electrode (Working Electrode)]

By the use of the above positive electrode active material, a positive electrode slurry was prepared in a manner similar to that of the example of the first example. Next, the slurry was applied to two surfaces of a positive electrode collector formed of aluminum and was then dried. The application amount thereof was 200 g/m² per one surface. Finally, after rolling was performed using rollers, a predetermined electrode size was obtained by cutting, and a positive electrode lead was further fitted thereto, so that a working electrode functioning as a positive electrode (application area: 2.5 cm×5.0 cm) was formed.

[Formation of Negative Electrode (Counter Electrode) and Reference Electrode]

A lithium metal was used for both a counter electrode functioning as a negative electrode and a reference electrode.

[Preparation of Nonaqueous Electrolyte Solution]

In a mixed solvent in which EC (ethylene carbonate), EMC (ethyl methyl carbonate), and DMC (dimethyl carbonate) were mixed together at a volume ratio of 3:3:4, LiPF₆ functioning as a solute, vinylene carbonate, and lithium bis(oxalato)borate were dissolved so as to have concentrations of 1.0 mole/liter, 1 percent by mass, and 0.1 mole/liter, respectively, so that a nonaqueous electrolyte solution was prepared.

[Formation of Three-Electrode Type Test Battery]

As shown in FIG. 2, separators 13 were each provided between the positive electrode (working electrode) 11 and the negative electrode (counter electrode) 12 and between the positive electrode (working electrode) 11 and a reference electrode 14, and those electrodes were enclosed by an aluminum laminate 15 together with the separators, so that an aluminum laminate cell (three-electrode type test battery) was formed. Hereinafter, the battery thus formed was called a battery C1.

### Comparative Example 1

Except that no lithium bis(oxalato)borate was added to the nonaqueous electrolyte solution, a battery was formed in a manner similar to that of the example 1 of the third example. Hereinafter, the battery thus formed was called a battery Y1.

### Example 2

In the synthesis of the positive electrode active material, except that lanthanum nitrate hexahydrate was used instead of erbium nitrate pentahydrate, and a lithium nickel cobalt manganate represented by LiNi_{0.35}Co_{0.35}Mn_{0.30}O₂ and having a surface to which lanthanum oxyhydroxide was uniformly adhered was obtained, a battery was formed in a manner similar to that of the example 1 of the third example. Hereinafter, the battery thus formed was called a battery C2.

### Comparative Example 2

Except that no lithium bis(oxalato)borate was added to the nonaqueous electrolyte solution, a battery was formed in a manner similar to that of the example 2 of the third example. Hereinafter, the battery thus formed was called a battery Y2.

### Example 3

In the synthesis of the positive electrode active material, except that neodymium nitrate hexahydrate was used instead of erbium nitrate pentahydrate, and a lithium nickel cobalt manganate represented by LiNi_{0.35}Co_{0.35}Mn_{0.30}O₂ and having a surface to which neodymium oxyhydroxide was uniformly adhered was obtained, a battery was formed in a manner similar to that of the example 1 of the third example. Hereinafter, the battery thus formed was called a battery C3.

### Comparative Example 3

Except that no lithium bis(oxalato)borate was added to the nonaqueous electrolyte solution, a battery was formed in a manner similar to that of the example 3 of the third example. Hereinafter, the battery thus formed was called a battery Y3.

### Example 4

In the synthesis of the positive electrode active material, except that samarium nitrate hexahydrate was used instead of erbium nitrate pentahydrate, and a lithium nickel cobalt manganate represented by LiNi_{0.35}Co_{0.35}Mn_{0.30}O₂ and having a surface to which samarium oxyhydroxide was uniformly adhered was obtained, a battery was formed in a manner similar to that of the example 1 of the third example. Hereinafter, the battery thus formed was called a battery C4.

### Comparative Example 4

Except that no lithium bis(oxalato)borate was added to the nonaqueous electrolyte solution, a battery was formed in a manner similar to that of the example 4 of the third example. Hereinafter, the battery thus formed was called a battery Y4.

### Comparative Example 5

Except that no erbium oxyhydroxide was adhered to the surface of the lithium nickel cobalt manganate, a battery was formed in a manner similar to that of the example 1 of the third example. Hereinafter, the battery thus formed was called a battery Y5.

### Comparative Example 6

Except that no lithium bis(oxalato)borate was added to the nonaqueous electrolyte solution, a battery was formed in a manner similar to that of the comparative example 5 of the third example. Hereinafter, the battery thus formed was called a battery Y6.

<Evaluation of Discharge Performance>

The discharge performance of each of the above batteries C1 to C4 and Y1 to Y6 was evaluated under the following conditions.

Charge/Discharge Conditions 1

Under a temperature condition at 25° C., constant current charge was performed at a current density of 0.1 It (0.01 A) until the potential reached 4.5 V (vs. Li/Li⁺), and furthermore, constant potential charge was performed at a constant potential of 4.5 V (vs. Li/Li⁺) until the current density reached 0.02 It (0.002 A). Subsequently, constant current discharge was further performed at a current density of 0.1 It (0.01 A) until the potential reached 2.5 V (vs. Li/Li⁺).

Charge/Discharge Conditions 2 (Cycle Test)

Furthermore, under a temperature condition at 25° C., constant current charge was performed at a current density of 2 It (0.2 A) until the potential reached 4.5 V (vs. Li/Li⁺), and furthermore, constant potential charge was performed at a constant potential of 4.5 V (vs. Li/Li⁺) until the current density reached 0.02 It (0.002 A). Subsequently, constant current discharge was further repeatedly performed 10 times on each cell at a current density of 2 It (0.2 A) until the potential reached 2.5 V (vs. Li/Li⁺), and a capacity retention after 10 cycles was measured. The results are shown in Table 3.

In this case, the capacity retention after 10 cycles of each of the batteries C1 to C4 and Y1 to Y6 is shown by a relative value obtained when the capacity retention after 10 cycles of the battery C1 is set to 100.

TABLE 3

| | | | Concen- | Capacity |
|---|---|---|---|---|
| | | Rare Earth | tration of | Retention |
| | | Oxyhydroxide | LiBOB | after 10 |
| Bat- | Positive Electrode | (Adhesion | (Mole/ | Cycles |
| tery | Active Material | Amount) | Liter) | (%) |
| C1 | LiNi_{0.35}Co_{0.35}Mn_{0.30}O₂ | Erbium | 0.1 | 100.0 |
| Y1 | | (Er) (0.1 per- | — | 85.2 |
| | | cent by mole) | | |
| C2 | | Lanthanum | 0.1 | 87.8 |
| Y2 | | (La) (0.1 per- | — | 81.0 |
| | | cent by mole) | | |
| C3 | | Neodymium | 0.1 | 97.1 |
| Y3 | | (Nd) (0.1 per- | — | 80.8 |
| | | cent by mole) | | |
| C4 | | Samarium | 0.1 | 99.8 |
| Y4 | | (Sm) (0.1 per- | — | 84.4 |
| | | cent by mole) | | |
| Y5 | | — | 0.1 | 87.0 |
| Y6 | | — | — | 80.9 |

As shown in Table 3, in the case in which the compound of a rare earth element, such as erbium, lanthanum, neodymium, or samarium is adhered to the surface of the lithium nickel cobalt manganate, the capacity retention after the cycles of each of the batteries Y1 to Y4 in which no LiBOB is added to the nonaqueous electrolyte solution is decreased. On the other hand, the capacity retention after the cycles of each of the batteries C1 to C4 in which the rare earth compound is adhered to the surface of the lithium nickel cobalt manganate and in which LiBOB is also added to the nonaqueous electrolyte solution is increased higher not only than that of each of the batteries Y1 to Y4 but also than that of the battery Y5, and hence it is found that the large current discharge performance of the above batteries is excellent. The reason for this is believed that in the batteries C1 to C4, the good coating film excellent in lithium ion conductivity described above is formed on the surface of the lithium nickel cobalt manganate. In contrast, as for the batteries Y1 to Y4 and Y6, since no LiBOB is added to the electrolyte solution, a coating film excellent in lithium ion conductivity is not likely to be formed on the surface of the lithium transition metal oxide; hence, it is believed that the effect of improving the capacity retention after 10 cycles cannot be obtained. In addition, as for the battery Y5, when the rare earth compound is not adhered to the surface of the lithium nickel cobalt manganate, even if lithium bis(oxalato)borate is added, a coating film excellent in lithium ion conductivity is not likely to be formed on the positive electrode active material as compared to the case in which the rare earth compound is adhered to the surface of the lithium nickel cobalt manganate; hence, it is believed that the above effect cannot be obtained.

In the examples, as the rare earth element of the rare earth compound, although erbium, lanthanum, neodymium, and samarium are used, since a good coating film excellent in lithium ion conductivity is expected to be formed by selective bonding between a rare earth element and an oxalate complex, it is believed that an effect similar to that described above can also be obtained by using another rare earth element.

In addition, compared to the battery C2 in which the lanthanum compound is adhered to the surface of the lithium nickel cobalt manganate, it is found that in the batteries C1, C3, and C4 in which the compounds of erbium, neodymium, and samarium are each adhered to the surface of the lithium nickel cobalt manganate, the capacity retention after the cycles is more improved, and the large current discharge performance is excellent. The reason for this is believed that since the average particle diameter of the compound of erbium, neodymium, or samarium is smaller than that of lanthanum, the compounds described above are each likely to be uniformly precipitated on the surface of the positive electrode active material. Hence, it is more preferable to adhere the compound of erbium, neodymium, or samarium to the surface of the lithium nickel cobalt manganate.

### Fourth Example

### Example 1

### Synthesis of Positive Electrode Active Material

A positive electrode active material was synthesized in a manner similar to that of the example of the first example.

[Formation of Positive Electrode (Working Electrode)]

By the use of the above positive electrode active material, a positive electrode slurry was prepared in a manner similar to that of the example of the first example. Next, the slurry was applied to one surface of a positive electrode collector formed of aluminum and was then dried. The application amount thereof was 100 g/m². Finally, after a predetermined electrode size was obtained by cutting, rolling was performed using rollers, and a positive electrode lead was further fitted, so that a working electrode functioning as a positive electrode (application area: 2.5 cm×5.0 cm) was formed.

[Formation of Negative Electrode (Counter Electrode) and Reference Electrode]

A lithium metal was used for both a counter electrode functioning as a negative electrode and a reference electrode.

[Preparation of Nonaqueous Electrolyte Solution]

In a mixed solvent in which EC (ethylene carbonate), EMC (ethyl methyl carbonate), and DMC (dimethyl carbonate) were mixed together at a volume ratio of 3:3:4, LiPF₆ functioning as a solute, vinylene carbonate, and lithium bis(oxalato)borate were dissolved to have concentrations of 1.0 mole/liter, 1 percent by mass, and 0.1 mole/liter, respectively, so that a nonaqueous electrolyte solution was prepared.

[Formation of Three-Electrode Type Test Battery]

As shown in FIG. 2, separators 13 were each provided between the positive electrode (working electrode) 11 and the negative electrode (counter electrode) 12 and between the positive electrode 11 and a reference electrode 14, and those electrodes were enclosed by an aluminum laminate 15 together with the separators, so that an aluminum laminate cell (three-electrode type test battery) was formed. Hereinafter, the battery thus formed was called a battery D1.

### Example 2

Except that a lithium nickel cobalt manganate represented by LiNi_{0.35}Co_{0.35}Mn_{0.30}O₂ was used as the positive electrode active material instead of using the lithium nickel cobalt manganate represented by LiNi_{0.55}Co_{0.20}Mn_{0.25}O₂, a battery was formed in a manner similar to that of the example of the first example. In addition, the adhesion amount of the erbium oxyhydroxide based on the erbium element was 0.1 percent by mole with respect to the total moles of the transition metals of the above lithium nickel cobalt manganate. Hereinafter, the battery thus formed was called a battery D2.

### Example 3

Except that a lithium nickel cobalt aluminate represented by LiNi_{0.80}Co_{0.15}Al_{0.05}O₂ was used as the positive electrode active material instead of using the lithium nickel cobalt manganate represented by LiNi_{0.55}Co_{0.20}Mn_{0.25}O₂, a battery was formed in a manner similar to that of the example of the first example. In addition, the adhesion amount of the erbium oxyhydroxide based on the erbium element was 0.1 percent by mole with respect to the total moles of the transition metals of the above lithium nickel cobalt aluminate. Hereinafter, the battery thus formed was called a battery D3.

### Example 4

Except that a lithium cobaltate represented by LiCoO₂ was used as the positive electrode active material instead of using the lithium nickel cobalt manganate represented by LiNi_{0.55}Co_{0.20}Mn_{0.25}O₂, a battery was formed in a manner similar to that of the example of the first example. In addition, the adhesion amount of the erbium oxyhydroxide based on the erbium element was 0.1 percent by mole with respect to the total mole of the transition metal of the above lithium cobaltate. Hereinafter, the battery thus formed was called a battery D4.

### Comparative Example 1

Except that no lithium bis(oxalato)borate was added to the electrolyte solution, an aluminum laminate cell was formed in a manner similar to that of the example 1 of the fourth example. Hereinafter, the battery thus formed was called a battery X1.

### Comparative Example 2

Except that no lithium bis(oxalato)borate was added to the electrolyte solution, an aluminum laminate cell was formed in a manner similar to that of the example 2 of the fourth example. Hereinafter, the battery thus formed was called a battery X2.

### Comparative Example 3

Except that no lithium bis(oxalato)borate was added to the electrolyte solution, an aluminum laminate cell was formed in a manner similar to that of the example 3 of the fourth example. Hereinafter, the battery thus formed was called a battery X3.

### Comparative Example 4

Except that no lithium bis(oxalato)borate was added to the electrolyte solution, an aluminum laminate cell was formed in a manner similar to that of the example 4 of the fourth example. Hereinafter, the battery thus formed was called a battery X4.

<Evaluation of Low Temperature Discharge Performance>

The discharge performance of each of the above batteries D1 to D4 and X1 to X4 was evaluated under the following conditions.

Charge/Discharge Conditions 1

Under a temperature condition at 25° C., constant current charge was performed at a current density of 0.1 It (0.0025 A) until the potential reached 4.5 V (vs. Li/Li⁺), and furthermore, constant potential charge was performed at a constant potential of 4.5 V (vs. Li/Li⁺) until the current density reached 0.02 It (0.0005 A). Subsequently, constant current discharge was further performed at a current density of 0.1 It (0.0025 A) until the potential reached 2.5 V (vs. Li/Li⁺).

Charge/Discharge Conditions 2 (Cycle Test)

Furthermore, under a temperature condition at 25° C., constant current charge was performed at a current density of 2 It (0.05 A) until the potential reached 4.5 V (vs. Li/Li⁺), and furthermore, constant potential charge was performed at a constant potential of 4.5 V (vs. Li/Li⁺) until the current density reached 0.02 It (0.0005 A). Subsequently, constant current discharge was further repeatedly performed 10 times on each cell at a current density of 2 It (0.05 A) until the potential reached 2.5 V (vs. Li/Li⁺), and a capacity retention after 10 cycles was measured. The results are shown in Table 4.

In this case, the capacity retention after 10 cycles of each of the batteries D2 to D4 and X1 to X4 is shown by a relative value obtained when the capacity retention after 10 cycles of the battery D1 is set to 100.

TABLE 4

| | | Presence of | | Capacity |
|---|---|---|---|---|
| | | Adhesion of | Presence | Retention |
| Bat- | Positive Electrode | Erbium Oxy- | of | after 10 |
| tery | Active Material | hydroxide | LiBOB | Cycles (%) |
| D1 | LiNi_{0.55}Co_{0.20}Mn_{0.25}O₂ | Yes | Yes | 100.0 |
| X1 | | Yes | No | 99.3 |
| D2 | LiNi_{0.35}Co_{0.35}Mn_{0.30}O₂ | Yes | Yes | 99.8 |
| X2 | | Yes | No | 99.0 |
| D3 | LiNi_{0.80}Co_{0.15}Al_{0.05}O₂ | Yes | Yes | 97.7 |
| X3 | | Yes | No | 97.2 |
| D4 | LiCoO₂ | Yes | Yes | 100.0 |
| X4 | | Yes | No | 98.5 |

As shown in Table 4, it is found that the capacity retention after 10 cycles of each of the batteries D1 to D4 of the present invention is improved as compared to that of each of the batteries X1 to X4 of the comparative examples. Accordingly, the reason for this is believed that when a lithium nickel cobalt manganate which satisfy the range of the general formula of LiₐNiₓCo_{y}Mn_{z}O₂ (0.95<a<1.20, 0.30≦x≦0.80, 0.10≦y≦0.40, and 0.10≦z≦0.50), a lithium nickel cobalt aluminate which satisfy the range of the general formula of LiₐNiₓCo_{y}Al_{z}O₂ (0.95<a<1.20, 0.50≦x≦0.99, 0.01≦y≦0.50, and 0.01≦z≦0.10), or a lithium cobaltate is used as the lithium transition metal oxide, rare earth-based erbium oxyhydroxide (rare earth compound) adhered to the surface of the lithium transition metal oxide and LiBOB (lithium salt functioning as an additive) added to the electrolyte solution are allowed to react with each other during charge, and as a result, the above-described good coating film having lithium ion conductivity can be reliably formed on the surface of the lithium transition metal oxide. In contrast, the reason a high capacity retention cannot be obtained by the batteries X1 to X4 in each of which no LiBOB is added to the electrolyte solution is believed that when no LiBOB was added to the nonaqueous electrolyte solution, a coating film having excellent lithium ion conductivity is not likely to be formed on the surface of the lithium transition metal oxide.

In addition, in this example, when the lithium nickel cobalt aluminate is used, although the effect of improving the capacity retention is decreased, in the case of the lithium nickel cobalt aluminate, rare earth-based erbium oxyhydroxide (rare earth compound) adhered to the surface thereof and LiBOB (lithium salt functioning as an additive) added to the electrolyte solution are allowed to react with each other during charge, and the above-described good coating film having lithium ion conductivity can be reliably formed on the surface of the lithium transition metal oxide, so that the effect of the present invention can also be obtained. However, since a resistance layer formed of NiO is present on the surface of the lithium nickel cobalt aluminate, a more significant effect can be obtained when a lithium nickel cobalt manganate or a lithium cobaltate is used.

By the reasons as described above, when Ni is contained in the lithium transition metal oxide, a lithium nickel cobalt manganate in which the average oxidation number of Ni in the active material is less than 2.9 is preferably used, and a lithium nickel cobalt manganate in which the average oxidation number of Ni in the active material is less than 2.66 is more preferably used. The reason for this is that by a lithium nickel cobalt aluminate having an average oxidation number of Ni of 3, the ratio of the resistance layer formed of NiO is increased at the surface of the active material.

In the above examples, as the nonaqueous electrolyte secondary battery, although the cylindrical battery and the three-electrode type battery have been described by way of example, the present invention is not limited thereto.

### REFERENCE SIGNS LIST

1 positive electrode
2 negative electrode
3 separator
4 electrode body
5 negative electrode can
6 sealing body
10 cylindrical nonaqueous electrolyte secondary battery
11 positive electrode (working electrode)
12 negative electrode (counter electrode)
13 separator
14 reference electrode
15 aluminum laminate
20 three-electrode type test battery

1. A nonaqueous electrolyte secondary battery comprising: a positive electrode containing a positive electrode active material; a negative electrode; and a nonaqueous electrolyte,
wherein the positive electrode active material contains a lithium transition metal oxide having a surface to which a rare earth compound is adhered, and the nonaqueous electrolyte contains a lithium salt in which an oxalate complex functions as an anion, and
wherein the concentration of the lithium salt in which the oxalate complex functions as an anion is 0.005 to 0.5 mole/liter with respect to an electrolyte solution.

2. (canceled)

3. (canceled)

4. (canceled)

5. (canceled)

6. (canceled)

7. The nonaqueous electrolyte secondary battery according to claim 1,
wherein the lithium transition metal oxide comprises a lithium nickel cobalt manganate in which the average oxidation number of Ni is less than 2.66.

8. The nonaqueous electrolyte secondary battery according to claim 1, wherein the lithium salt includes an oxalate compound of boron or phosphorus.

9. The nonaqueous electrolyte secondary battery according to claim 7, wherein the lithium salt includes an oxalate compound of boron or phosphorus.

10. The nonaqueous electrolyte secondary battery according to claim 1, wherein the concentration of the lithium salt in which the oxalate complex functions as an anion is 0.01 to 0.2 mole/liter with respect to an electrolyte solution.

11. The nonaqueous electrolyte secondary battery according to claim 7, wherein the concentration of the lithium salt in which the oxalate complex functions as an anion is 0.01 to 0.2 mole/liter with respect to an electrolyte solution.

12. The nonaqueous electrolyte secondary battery according to claim 1, wherein the lithium salt includes lithium bis(oxalato)borate.

13. The nonaqueous electrolyte secondary battery according to claim 7, wherein the lithium salt includes lithium bis(oxalato)borate.

14. The nonaqueous electrolyte secondary battery according to claim 1, wherein the rare earth compound comprising at least one element selected from the group consisting of erbium, lanthanum, neodymium and samarium, said rare earth compound is at least one substance selected from the group consisting of a hydroxide, an oxyhydroxide and an oxide.

15. The nonaqueous electrolyte secondary battery according to claim 7, wherein the rare earth compound comprising at least one element selected from the group consisting of erbium, lanthanum, neodymium and samarium, said rare earth compound is at least one substance selected from the group consisting of a hydroxide, an oxyhydroxide and an oxide.
